(19) United States
(12) Patent Application Publication
(10) Pub. No.: US 2021/0262375 A1
(43) Pub. Date: Aug. 26, 2021

(54) EXHAUST AFTERTREATMENT SYSTEM WITH SCOOPED INLET

(71) Applicant: CNH Industrial America LLC, New Holland, PA (US)

(72) Inventors: Kaushal Ghorpade, Chicago, IL (US); Samrendra K. Singh, Bolingbrook, IL (US); Rowland J. Milburn, JR., Naperville, IL (US); Panos Tamamidis, Mount Prospect, IL (US)

(73) Assignee: CNH Industrial America LLC, New Holland, PA (US)

(21) Appl. No.: 16/802,009

(22) Filed: Feb. 26, 2020

(51) Int. Cl. F01N 3/28; F01N 3/20; B01F 5/06

(52) U.S. Cl. CPC F01N 3/2892; F01N 3/2073; F01N 2610/02; F01N 2240/20; B01F 5/0616

(57) ABSTRACT

An inlet duct of an exhaust system for treating an exhaust fluid with a reductant. The inlet duct includes a shell body that has a first end with a first opening therein for receiving an exhaust duct, a second end, and a side. The inlet duct also includes a chamber internally disposed within the shell body and defining a fluid passageway therethrough, and a scooped member connected to and extending outwardly from the side. The scooped member has a second opening, and the scooped member is configured for causing a turbulent fluid flow of the exhaust fluid and the reductant.

### BACKGROUND OF THE INVENTION

The present invention pertains to agricultural work vehicles and, more specifically, to exhaust systems for agricultural work vehicles.

A typical work vehicle includes a chassis, wheels and/or tracks supporting the chassis, an operator cab, a prime mover, and an exhaust system. Often, the prime mover is configured as a diesel engine to provide the necessary torque for pulling heavy equipment and/or hauling heavy loads. To comply with modern emission requirements, the exhaust system must generally include various exhaust treatment systems for reducing the level carbon dioxide (CO₂), nitrous oxides (NOₓ), and/or diesel particulate matter (DPM).

A typical exhaust treatment system has one or more aftertreatment devices, such as an exhaust gas recirculation (EGR) device, a diesel particulate filter (DPF), a selective catalytic reduction (SCR) device, or a catalytic converter, for example a diesel oxidation catalyst (DOC). A SCR device generally involves the process of injecting a redundant, such as automotive-grade urea, into the exhaust stream and screening the combined fluid stream through catalysts and/or filters. Through the SCR device, NOₓ reduction reactions occur which accordingly convert the nitrogen oxides into nitrogen, water, and nominal amounts of CO₂.

It is difficult to adequately mix and balance the urea in the exhaust stream through parallel substrate lines for effectively meeting a desired NOₓ conversion rate. Generally, the exhaust system will include a designated mixer located in the DOC; however, the mixer does not effectively mix the urea and the exhaust. Thus, known mixers may cause lower exhaust and urea uniformity indices and an unbalanced flow.

What is needed in the art is an exhaust gas system that adequately mixes and balances the urea in the exhaust stream.

### SUMMARY OF THE INVENTION

In one exemplary embodiment formed in accordance with the present invention, there is provided a scooped inlet duct of an SCR canister. The inlet duct has a shell body and a scooped member connected to and extending outwardly from the side of the shell body. The scooped member is configured for causing a turbulent fluid flow of an exhaust fluid and a reductant to accordingly increase the mixing time of the reductant into the exhaust fluid.

In another exemplary embodiment formed in accordance with the present invention, there is provided an inlet duct of an exhaust system for treating an exhaust fluid with a reductant. The inlet duct includes a shell body that has a first end with a first opening therein for receiving an exhaust duct, a second end, and a side. The inlet duct also includes a chamber internally disposed within the shell body and defining a fluid passageway therethrough, and a scooped member connected to and extending outwardly from the side. The scooped member has a second opening, and the scooped member is configured for causing a turbulent fluid flow of the exhaust fluid and the reductant.

In yet another exemplary embodiment formed in accordance with the present invention, there is provided an exhaust system for treating an exhaust fluid with a reductant. The exhaust system includes an exhaust duct and an inlet duct connected to the exhaust duct. The inlet duct includes a shell body that has a first end with a first opening therein for receiving an exhaust duct, a second end, and a side. The inlet duct also includes a chamber internally disposed within the shell body and defining a fluid passageway therethrough, and a scooped member connected to and extending outwardly from the side. The scooped member has a second opening, and the scooped member is configured for causing a turbulent fluid flow of the exhaust fluid and the reductant.

One possible advantage of the exemplary embodiment of the scooped inlet of the exhaust system is that the scooped inlet further turbulates the combined fluid flow and thus allows for better exhaust-urea mixing to create a more balanced fluid stream through the SCR canister.

### BRIEF DESCRIPTION OF THE DRAWINGS

For the purpose of illustration, there are shown in the drawings certain embodiments of the present invention. It should be understood, however, that the invention is not limited to the precise arrangements, dimensions, and instruments shown. Like numerals indicate like elements throughout the drawings. In the drawings:

FIG. 1 illustrates a perspective view of an exemplary embodiment of an exhaust system for a work vehicle, the exhaust system comprising a diesel oxidation catalyst and a downstream selective catalytic reduction device, in accordance with an exemplary embodiment of the present invention;

FIG. 2 illustrates a perspective view of the SCR device of FIG. 1, the SCR device has a scooped inlet duct;

FIG. 3 illustrates a perspective view of the scooped inlet duct of FIGS. 1-2;

FIG. 4 illustrates another exemplary embodiment of a scooped inlet duct, in accordance with an exemplary embodiment of the present invention; and

FIG. 5 illustrates yet another exemplary embodiment of a scooped inlet duct, in accordance with an exemplary embodiment of the present invention.

### DETAILED DESCRIPTION OF THE INVENTION

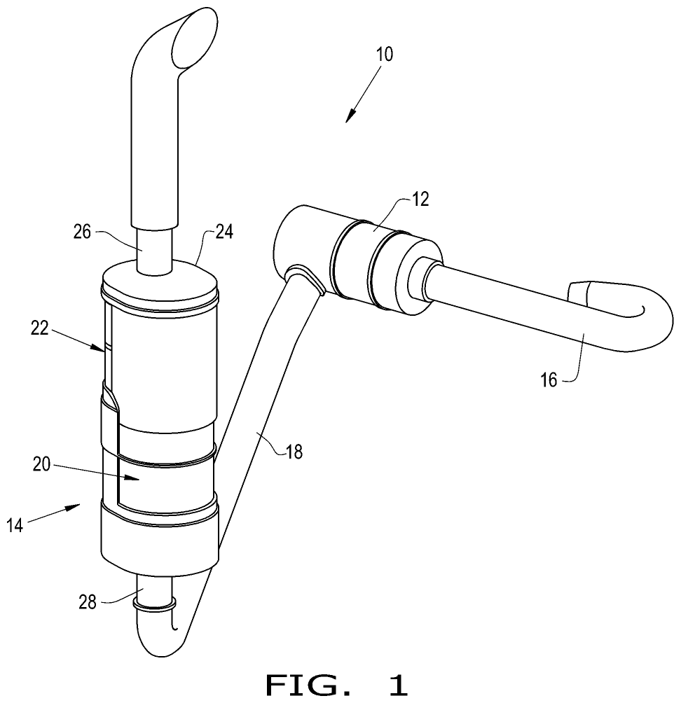

Referring now to the drawings, and more particularly to FIGS. 1-3, there is shown an exhaust system 10 of a work vehicle. The work vehicle may be in the form of any desired work vehicle such as a tractor or combine harvester. The exhaust system 10 may be configured for treating the exhaust fluid of the prime mover with a reductant, such as urea. The exhaust system generally includes a diesel oxidation catalyst (DOC) 12, a selective catalytic reduction (SCR) device or canister 14 that is downstream of the DOC 12, and various connecting exhaust ducts 16, 18. The DOC 12 may be in the form of any desired DOC 12. The SCR device 14 may generally include at least one monolith 20, 22 comprised of SCR and/or SCRoF substrates and a housing 24 for housing the monolith(s) 20, 22. The SCR device 14 may further include an outlet duct 26 and an inlet duct 28.

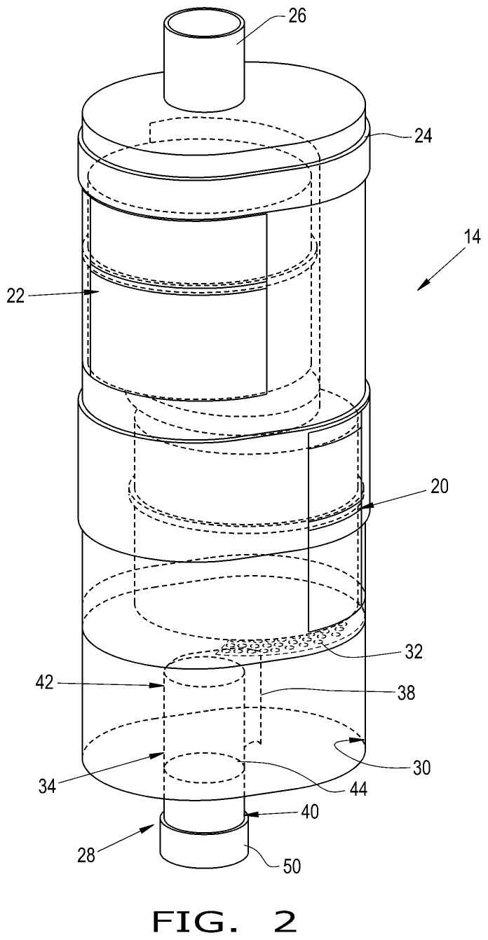

The inlet duct 28 is connected to the exhaust duct 18 and the housing 24, upstream of the monolith(s) 20, 22. The inlet duct 28 at least partially extends within the housing 24, inside an inlet chamber 30 (FIG. 2). The inlet duct 28 also at least partially extends outside of and below the housing 24. The inlet duct 28 further turbulates the fluid flow of the exhaust fluid and the reductant before the fluid flow passes to the monolith(s) 20, 22 through a perforated baffle 32. Hence, the inlet duct 28 further mixes the combined fluid by twisting the fluid flow before it enters the inlet chamber 30, which correspondingly increases the mixing volume and the time during which the fluid flow is turbulent. Furthermore, the inlet duct 28 may increase uniformity of the combined fluid flow at the SCR device 14, and increase water uniformity of the combined fluid flow at the SCR device 14. During operation, the exhaust back pressure may be lower than 300 mbar. The inlet duct 28 may comprise any desired material, such as metal.

The inlet duct 28 may generally include a shell body 34, a chamber 36 disposed within the shell body 34, and a scooped or scroll member 38. The shell body 34 includes a first, open end 40, a second, closed end 42, and a side 44. The first end 40 has a first opening therein, which has a circular cross-section, for receiving the exhaust duct 18. The chamber 36 defines a fluid passageway therethrough which is fluidly connected to the first opening and the scooped member 38. The scooped member 38 is connected to and extends outwardly away from the side 44. The scooped member 38 has a second, scoop opening 46 and an arcuate portion 48 extending from the side 44. The scoop opening 46 is defined by the arcuate portion 48 and the side 44 of the body 34. The scoop opening 46 is substantially perpendicular to the first opening. The scoop opening 46 has a rectangular cross-section. However, it should be appreciated that the scoop opening 46 may have a differing cross-sectional shape, such as a circular cross-section. The arcuate portion 48 has an inner surface, which includes the entire inner surface of the scooped member 38, for engaging with and twisting the combined fluid flow. It should be appreciated that the inlet duct 28 may include two or more scoop members 38 that extend outwardly from the side 44 of the body 34.

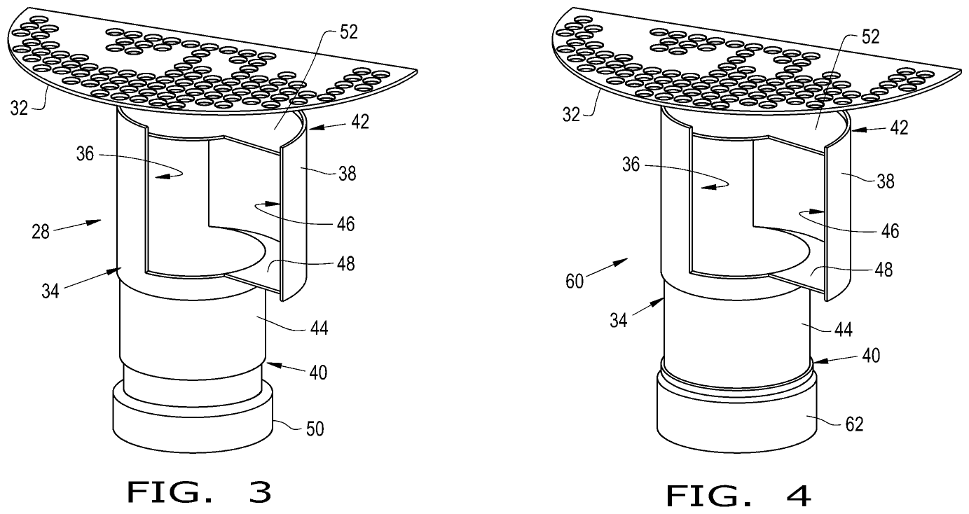

The inlet duct 28 may further include a lip 50 connected to the first end 40 and an end plate 52 connected to the second end 42 such that the second end 42 is closed (FIG. 3). The lip 50 may be welded onto the inside of the first end 40. The lip 50 may act as the intermediary connecting component which connects the body 34 to the exhaust duct 18. The end plate 52 closes off the second end 42 so that the combined fluid flow first engages with the inside of the end plate 52 and subsequently engages with the scooped member 38 and exits through its opening 46. In other words, the closed end 42 in combination with the scooped member 38 adds an additional twist in the fluid flow and accordingly increases the amount of time for mixing the urea in the exhaust fluid. The end plate 52 may be welded to or integrally formed with the second end 42. The end plate 52 is shown to have a teardrop cross-sectional shape; however, the end plate 52 may have any desired cross-sectional shape. It should be appreciated that the end plate 52 may be in the form of an end wall to which the second end 42 is connected. For example, if the inlet duct 28 is incorporated into a reloader, the second end 42 may be directly welded to the side of a canister.

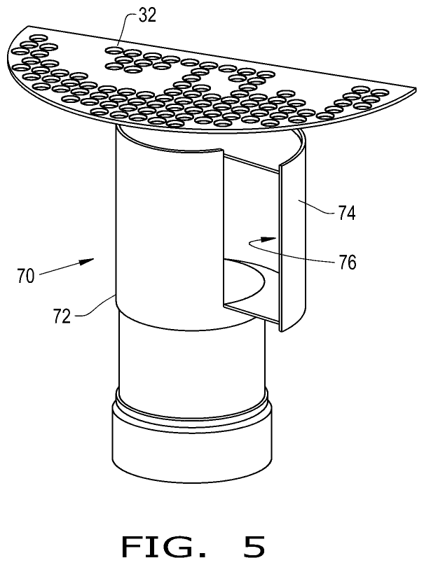

Referring now to the drawings, and more particularly to FIG. 4, there is shown another embodiment of an inlet duct 60 with the lip 62 welded on the outside of the first end 40. Like elements have been identified with like reference characters. The exterior lip 62 may effectively increase the diameter of the opening of the inlet duct 60, which may accordingly decrease the pressure within the inlet duct 60 for decreasing the overall backpressure of exhaust system 10.

Referring now to the drawings, and more particularly to FIG. 5, there is shown another embodiment of an inlet duct 70 which may be substantially similar to either inlet duct 28, 60, as discussed above, except that the shell body 72 and the scooped member 74 form a smaller scoop opening 76. Like elements have been identified with like reference characters. The smaller opening 76 may increase the pressure within the inlet duct 70, which may assist the mixing of the urea into the exhaust fluid.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

1. An inlet duct of an exhaust system for treating an exhaust fluid with a reductant, comprising:
a shell body comprising a first end with a first opening therein for receiving an exhaust duct, a second end, and a side;
a chamber internally disposed within the shell body and defining a fluid passageway therethrough; and
a scooped member connected to and extending outwardly from the side, the scooped member comprising a second opening, and the scooped member is configured for causing a turbulent fluid flow of the exhaust fluid and the reductant.

2. The inlet duct of claim 1, wherein the scooped member twists the fluid flow of the exhaust fluid and the reductant as the exhaust fluid and reductant exit the fluid passage of the chamber through the second opening such that a mixing volume and a time during which the fluid flow is turbulent increases.

3. The inlet duct of claim 1, wherein the scooped member comprises an arcuate portion with an inner surface for engaging with and twisting the fluid flow of the exhaust fluid and the reductant.

4. The inlet duct of claim 1, further comprising an end plate connected to the second end such that the second end is closed.

5. The inlet duct of claim 4, wherein the scooped member is located adjacent to the second end such that the fluid flow of the exhaust fluid and the reductant first engage with the end plate and subsequently engage with the scooped member and exit through the second opening of the scooped member.

6. The inlet duct of claim 4, wherein the end plate comprises a teardrop cross-sectional shape.

7. The inlet duct of claim 1, wherein the second opening is perpendicular to the first opening.

8. The inlet duct of claim 1, wherein the first opening has a circular cross-section and the second opening has a rectangular cross-section.

9. The inlet duct of claim 1, further comprising a lip connected to the first end.

10. An exhaust system for treating an exhaust fluid with a reductant, comprising:
an exhaust duct; and
an inlet duct connected to the exhaust duct, and comprising:
a shell body comprising a first end with a first opening therein for receiving an exhaust duct, a second end, and a side;
a chamber internally disposed within the shell body and defining a fluid passageway therethrough; and
a scooped member connected to and extending outwardly from the side, the scooped member comprising a second opening, and the scooped member is configured for causing a turbulent fluid flow of the exhaust fluid and the reductant.

11. The exhaust system of claim 10, wherein the scooped member twists the fluid flow of the exhaust fluid and the reductant as the exhaust fluid and reductant exit the fluid passage of the chamber through the second opening such that a mixing volume and a time during which the fluid flow is turbulent increases.

12. The exhaust system of claim 10, wherein the scooped member comprises an arcuate portion with an inner surface for engaging with and twisting the fluid flow of the exhaust fluid and the reductant.

13. The exhaust system of claim 10, further comprising an end plate connected to the second end such that the second end is closed.

14. The exhaust system of claim 13, wherein the scooped member is located adjacent to the second end such that the fluid flow of the exhaust fluid and the reductant first engage with the end plate and subsequently engage with the scooped member and exit through the second opening of the scooped member.

15. The exhaust system of claim 13, wherein the end plate comprises a teardrop cross-sectional shape.

16. The exhaust system of claim 10, wherein the second opening is perpendicular to the first opening.

17. The exhaust system of claim 10, wherein the first opening has a circular cross-section and the second opening has a rectangular cross-section.

18. The exhaust system of claim 10, further comprising a lip connected to the first end.

19. The exhaust system of claim 10, further comprising a selective catalytic reduction (SCR) canister connected to the inlet duct, and the inlet duct is upstream of at least one monolith of the SCR canister.

20. The exhaust system of claim 10, wherein the reductant is urea, and the urea is injected into the exhaust fluid upstream of the inlet duct so that the inlet duct further mixes the exhaust fluid with the urea by turbulating the fluid flow of the exhaust fluid and the reductant.
